(19) United States
(12) Patent Application Publication
(10) Pub. No.: US 2010/0068459 A1
(43) Pub. Date: Mar. 18, 2010

(54) OPTICAL FILM

(75) Inventors: Yi-Chia Wang, Kaohsiung (TW); Jui-Kai Hu, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD.

(21) Appl. No.: 12/555,833

(22) Filed: Sep. 9, 2009

(30) Foreign Application Priority Data
Sep. 12, 2008 (TW) 097135257

(51) Int. Cl. B32B 5/16; B32B 27/00

(52) U.S. Cl. 428/147; 428/143

(57) ABSTRACT

The present invention relates to an optical film comprising a substrate having microstructures and a resin coating disposed on the microstructures of the substrate. The resin coating comprising a plurality of organic particles and a binder. The microstructures comprise a plurality of columnar structures which are equilateral, and the organic particles are tangent to the columnar structures. The height of the organic particles is not less than the height of the columnar structures. The optical film of the present invention enables the organic particles to be uniformly and orderly distributed so that the transmitting light is homogenized and the brightness can be enhanced.

### BACKGROUND OF THE INVENTION

1. Field of the Invention

The present invention relates to an optical film. In particular, the present invention relates to an optical film having highly uniform optical characteristics, and which is useful in a backlight module.

2. Description of the Prior Art

It is known that liquid crystal display (LCD) panels do not independently emit light. To properly display an image, a backlight module is required to serve as a light source providing sufficient and uniform brightness. A typical backlight module uniformly distributes and converges light rays by utilizing a diffusion plate, a diffusion film and a brightness enhancing film. The function of the diffusion plate and diffusion film is to provide a uniform area light source while the brightness enhancing film, also known as brightness enhancement film or prism film, converges the scattered light rays by refraction and internal total reflection, and converges the rays in the on-axis direction of about ±35 degrees to enhance the luminance of an LCD.

A conventional brightness enhancing film (as shown in FIG. 1 and disclosed in, for example, WO 96/23649 and U.S. Pat. No. 5,626,800), comprises a substrate (1) and a plurality of prisms (2) with parallel configuration, wherein each prism has two slant surfaces and said two slant surfaces meet at the top of the prism to form a peak (3). The two slant surfaces each meet a slant surface of the adjacent prism at the bottom of the prism to form a valley (4).

The prisms of a brightness enhancing film could be easily scratched when contacting the display panel or other films, adversely affecting the optical characteristics of the prisms. To prevent damage caused by abrasion with other films due to vibration during transport, the most common solution in the art is to utilize a protective diffusion film, also known as upper diffusion film. In addition to a protective diffusion film, other protective films might be needed during storage and transport to avoid scratches prior to assembly. Use of protective diffusion film and other protective films, however, increases manufacturing cost.

Conventional diffusion films are prepared by coating a resin binder and diffusion particles to form a diffusion layer on a transparent substrate. When light rays pass through a diffusion layer containing two media with different refractive indices, refraction, reflection and scattering occur so that the light rays are diffused and become uniform. The diffusion particles used in the art are varied widely in size so as to enhance diffusion. However, not all of the light rays are effectively utilized due to the randomness of the scattering. In addition, during the process of production, diffusion particles might aggregate or adhere to each other, reducing uniformity of the diffused light rays and potentially resulting in a dark spot on the display.

Moreover, brightness enhancing film is expensive relative to other optical films. To reduce cost, the industry tends to rely on new types of optical films or alter the configuration of other optical films to eliminate the need for brightness enhancing film. For example, transparent microlenses could be formed on a substrate and, due to the specific structure and characteristics of the material, the optical film would not only diffuse but also converge light rays. The optical film shown in FIG. 2 (which is disclosed in U.S. Pat. No. 7,265,907) has a transparent substrate (4) and rows of microlenses (20a) and (20b), each row comprising a plurality of microlenses (2a) and (2b). Manufacturing throughput according to this method is low, however, so its industrial applicability is limited. Another example disclosed in U.S. Pat. No. 7,265,907 (also TW 287644) is to form microlenses on a substrate by discharging droplets. Although it is asserted that the structure can be produced roll-to-roll, when droplets fall on the substrate, the rolling of the substrate must be paused until the droplets completely form microlenses. Accordingly, the structure cannot be produced by non-stop roll-to-roll processes such as slot die coating or roller coating.

The present invention provides an optical film which does not suffer from the abovementioned disadvantages.

### SUMMARY OF THE INVENTION

The optical film according to the present invention provides a specific structure which can block and confine the organic particles so as to reduce aggregation or adhesion of said organic particles and to render the particles orderly arranged. The optical film according to the present invention can converge and diffuse light rays, thereby enhancing the uniformity of the light rays and increasing the luminance.

In another aspect, the present invention provides a method for producing an optical film having microstructures by a continuous roll-to-roll technique. The method according to the present invention greatly increases the industrial applicability of the optical film.

To achieve the above and other goals, the present invention provides an optical film comprising a substrate having microstructures and a resin coating disposed thereon. The resin coating comprises organic particles and a binder, and the microstructures comprise a plurality of columnar structures that are equilateral, said organic particles are tangent to the columnar structures, and the geometry of at least part of the organic particles and microstructures satisfies the equation H_{b}≧H, in which H_{b} represents the vertical distance between the top of an organic particle to the bottom of a columnar structure and H represents the vertical distance between the apex and the bottom of a columnar structure.

### BRIEF DESCRIPTION OF THE DRAWINGS

FIG. 1 is a schematic illustration of a conventional brightness enhancing film.

FIG. 2 is a schematic illustration of a conventional optical film with microlens structures.

FIG. 3 is a schematic illustration of an embodiment of the optical film according to the present invention.

FIG. 4 is a cross-sectional view of an embodiment of the optical film according to the present invention.

FIG. 5 is a geometrically schematic diagram of a columnar structure and an organic particle in the optical film according to the present invention.

FIG. 6 is a schematic diagram showing the geometrical relationship between the bottom of a columnar structure and the center of an organic particle.

FIG. 7 is a schematic view of another embodiment of the optical film according to the present invention.

FIG. 8 is a schematic view of yet another embodiment of the optical film according to the present invention.

FIG. 9 is a schematic view of a further embodiment of the optical film according to the present invention.

FIG. 10 is a cross-sectional view of an optical film according to the present invention with arc-shaped columnar structures.

FIG. 11 is a top view of an embodiment of the optical film according to the present invention.

FIG. 12 is a top view of another embodiment of the optical film according to the present invention.

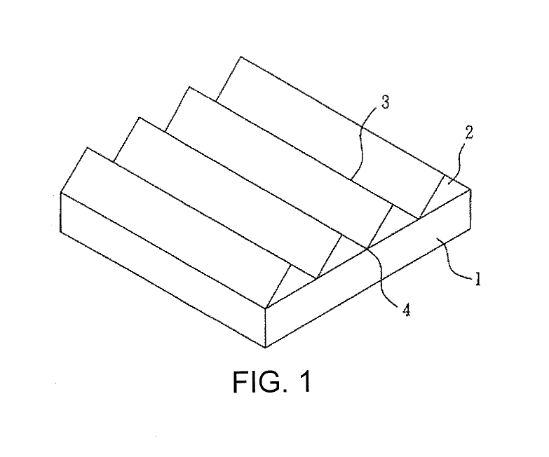

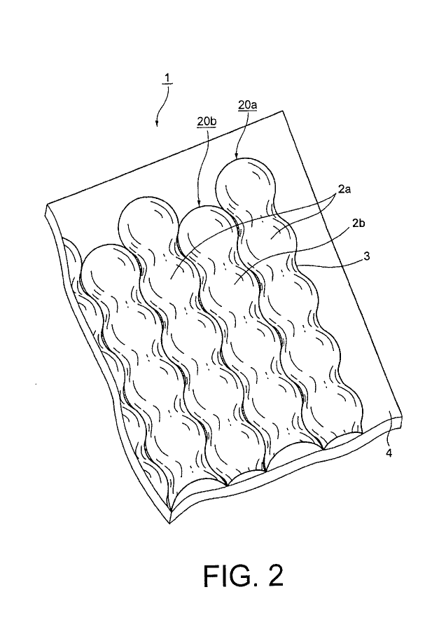

### DETAILED DESCRIPTION OF THE INVENTION

It should be understood that the detailed description, while indicating the preferred embodiments of the invention, is intended for purposes of illustration only and is not intended to limit the scope of the invention. For example, in the present disclosure, the words “a” and “an” are, unless otherwise indicated, to be taken to include both the singular and the plural.

In the context of the disclosure, the term “columnar structure” may represent a prismatic columnar structure, an arc-shaped columnar structure or a mixture thereof.

In the context of the disclosure, the term “prismatic columnar structure” represents a columnar structure having two slant surfaces that are flat. The slant surfaces meet at the top of a prism to form a peak, or are blunted to form a blunt-shaped surface.

In the context of the disclosure, the term “arc-shaped columnar structure” represents a columnar structure having two slant surfaces that are curved. The two slant surfaces meet at the top of the prism to form a peak or are blunted to form a blunt-shaped surface.

In the context of the disclosure, the term “linear columnar structure” represents a columnar structure with a linear ridge extending along the length direction.

In the context of the disclosure, the term “serpentine columnar structure” represents a columnar structure with a serpentine ridge extending along the length direction. The curvature of the serpentine ridge varies properly and the variation of the curvature is in a range of 0.2% to 100%, preferably 1% to 20%, of the nominal height of the serpentine columnar structure.

In the context of the disclosure, the term “zigzag columnar structure” represents a columnar structure with a zigzag ridge extending along the length direction.

In the context of the disclosure, the symbol “H” represents the height of a columnar structure, which is the vertical distance between the apex and the bottom of the columnar structure.

In the context of the disclosure, the symbol “H_{b}” represents the height of an organic particle, which is the vertical distance between the top of the organic particle and the bottom of a columnar structure.

In the context of the disclosure, the symbol “2θ” represents the apex angle formed by the two slant surfaces of a columnar structure.

In the context of the disclosure, the symbols “R” and “Rₐ” represent the radius of an organic particle and the average radius of the organic particles, respectively.

In the context of the disclosure, the symbol “r” represents the radius of curvature of an arc-shaped groove.

The optical film according to the present invention comprises a substrate having microstructures and a resin coating comprising a plurality of organic particles, wherein the microstructures comprise a plurality of columnar structures that confine the plurality of organic particles, reduce aggregation or adhesion of the organic particles and render the organic particles orderly arranged so as to efficiently converge and diffuse light rays and thereby enhance the uniformity of the light rays and increase the luminance.

The substrate having microstructures used in the present invention can be prepared by any methods known to a person of ordinary skill in the art. For example, the optical film can be prepared by embossing or injection; or by laminating a commercially available brightness enhancing film onto a substrate; or by utilizing continuous roll-to-roll techniques to apply a structured surface which is capable of converging light rays on a substrate. Commercially available brightness enhancing films suitable for the present invention include BEF90HP® C and BEF II 90/50 produced by Sumitomo 3M and DIA ART H150100® and P210 produced by Mitsubishi Rayon.

In one preferred embodiment according to the present invention, the substrate having microstructures is manufactured by utilizing continuous roll-to-roll techniques to apply a plurality of columnar structures on a surface of the substrate.

The columnar structures can be linear, serpentine or zigzag columnar structures. Two adjacent columnar structures can be parallel or not, and preferably are parallel. Two adjacent columnar structures can be or not be connected to each other. The groove formed between two columnar structures can be V-shaped, arc-shaped or of an inverted trapezoid.

The columnar structures used in the present invention are equilateral, can be of the same or different heights and widths, and can be prismatic columnar structures, arc-shaped columnar structures or a mixture thereof, of which the prismatic columnar structures are preferred. The apex angles of the prismatic or arc-shaped columnar structures can be the same or different and are in the range of 40° to 120°.

The resins used for forming the columnar structures in the present invention are those known to a person of ordinary skill in the art, which can be for example, thermosetting resins or energy ray-curable resins. The energy ray can be ultraviolet, infrared or visible rays or heat rays such as emission and radiation rays; the exposure intensity ranges from 1 to 500 mJ/cm², preferably from 50 to 300 mJ/cm². UV-curable resins are preferred. Examples of suitable UV-curable resins include, but are not limited to, acrylate resins such as (meth)acrylate resins, urethane acrylate resins, polyester acrylate resins, epoxy acrylate resins and a mixture thereof, of which (meth)acrylate resins are preferred.

The material of the substrate according to the present invention can be any suitable materials known to a person of ordinary skill in the art, for example, glass and plastic. A plastic substrate can be composed of one or more polymeric resin layers. The types of the resins used in the polymeric resin layers are not particularly restricted and can be, for example, but not limited to, any one selected from the group consisting of polyester resins such as polyethylene terephthalate (PET) and polyethylene naphthalate (PEN), polyacrylate resins such as polymethyl methacrylate (PMMA), polyolefin resins such as polyethylene (PE) and polypropylene (PE), polycycloolefin resins, polyimide resins, polycarbonate resins, polyurethane resins, triacetyl cellulose (TAC), polylactic acids and a combination thereof. Among the above, polyester resins, polycarbonate resins and a combination thereof are preferred and PET is more preferred. The thickness of the substrate usually depends on the requirements of the optical product and is normally in the range from 15 μm to 300 μm.

To diffuse light rays, the substrate having microstructures is coated by a resin coating comprising organic particles and a binder. The organic particles in the resin coating are not particularly limited and can be, for example but not limited to, polyacrylate resins, polystyrene resins, urethane resins, silicone resins or a mixture thereof. Among the above resins, polyacrylate resins and silicone resins are preferred, and polyacrylate resins comprising at least one acrylate monomer with a mono-functional group and at least one acrylate monomer with a multi-functional group as polymeric units are more preferred. In this case, the amount of the acrylate monomers having a multifunctional group is about 30 to 70%, based on the total weight of the monomers. Because the monomers used in the present invention include monomers having a multi-functional group, the cross-linking degree of the organic particles is increased due to the cross-linking reaction among the monomers, thereby increasing the hardness and abrasion resistance of the organic particles and their solvent resistance against the binder.

Suitable acrylate monomers with a mono-functional group can be selected from the group consisting of (but are not limited to) methyl methacrylate (MMA), butyl methacrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isoborny methacrylate, benzyl acrylate, 2-hydroxyethyl metharcrylate phosphate, hydroxyethyl acrylate (HEA), 2-hydroxyethyl methacrylate, (HEMA) and a mixture thereof.

Suitable acrylate monomers with a multi-functional group can be selected from the group consisting of (but are not limited to) hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate (EGDMA), diethylene glycol dimethacrylate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, tripropylene glycol dimethacrylate, 1,4-butanediol dimethacrylate, 1,6-hexanediol dimethacrylate, allylated cyclohexyl dimethacrylate, isocyanurate dimethacrylate, ethoxylated trimethylol propane tri-methacrylate, propoxylated glycerol tri-methacrylate, trimethylol propane tri-methacrylate, tris(acryloxyethyl) isocyanurate and a mixture thereof.

In a preferred embodiment according to the present invention, the organic particles in the resin coating are polyacrylate resin particles formed from the monomers of methyl methacrylate and ethylene glycol dimethacrylate, wherein the weight ratio of the methyl methacrylate monomers to the ethylene glycol dimethacrylate monomers is about 70:30, 60:40, 50:50, 40:60 or 30:70. When the amount of the ethylene glycol dimethacrylate monomers is about 30 to about 70 wt %, based on the total amount of the monomers, the cross-linking degree is better.

According to the present invention, the shape of the organic particles in the resin coating is not particularly limited and can be for example spherical, oval or irregular, among which spherical is preferred. The organic particles have an average particle size in the range of about 1 μm to about 100 μm, preferably in the range of about 2 μm to 50 μm, and more preferably in the range of 8 μm to 20 μm. Most preferably, the organic particles have an average particle size of 8, 10, 12, 15, 18, or 20 μm. The organic particles are capable of scattering light rays. To increase the luminance of the optical film, the organic particles used in the present invention have a narrow particle size distribution. The particle sizes of the organic particles fall within about ±30% of the average particle size, preferably within about ±15% of the average particle size. For example, according to the present invention, when the average particle size of the organic particles is about 15 μm and the particle size distribution fall within about ±30%, the particle sizes of the organic particles in the resin coating are in the range of about 10.5 μm to about 19.5 μm. In comparison with the organic particles used in prior art, which have an average particle size of about 15 μm and a particle size distribution falling within the range from about 1 μm to about 30 μm, the organic particles according to the present invention, which have an average particle size and a narrower particle size distribution, avoid the waste of light source due to the broad scattering range resulting from the significant difference in particle sizes and thereby enhance the luminance of the optical film.

In the resin coating according to the present invention, the organic particles are in an amount of about 100 to about 300 parts by weight, preferably about 120 to about 220 parts by weight, per 100 parts by weight of the solids content of the binder. The distribution pattern of the organic particles in the resin coating is not particularly limited, and preferably the organic particles are distributed uniformly as a single layer. The uniform single-layered distribution not only reduces the cost of the materials but also reduces the waste of the light source and thereby enhances the luminance of the optical film.

In order to allow transmittance of light rays, the binder used in the present invention is preferably transparent. The binder according to the present invention can be selected from UV-curable resins, thermosetting resins, thermoplastic resins and a mixture thereof, and the resins can optionally be processed by heat curing, UV curing, or heat and UV dual curing, so as to form the resin coating of the present invention. In an embodiment according to the present invention, the binder comprises a UV curable resin and a resin selected from the group consisting of thermosetting resins, thermoplastic resins and a mixture thereof and is treated by heat and UV dual curing to form a resin coating with excellent heat resistance and extremely low volume shrinkage, thereby increasing the hardness of the coating and preventing the film from warping.

The UV curable resins suitable for the present invention is formed from at least one acrylic monomer or acrylate monomer having one or more functional groups, of which the acrylate monomer is preferred. The acrylate monomers useful in the present invention include, for example, but are not limited to, methacrylate monomers, acrylic acid ester monomers, urethane acrylate monomers, polyester acrylate monomers or epoxy acrylate monomers, of which the acrylate monomers are preferred.

For example, the acrylate monomers suitable for the UV curable resin according to the present invention can be selected from the group consisting of methyl methacrylate, butyl acrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isoborny methacrylate, benzyl acrylate, hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate, diethylene glycol dimethacrylate, 2-hydroxyethyl metharcrylate phosphate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, hydroxyethyl acrylate (HEA), 2-hydroxyethyl methacrylate (HEMA), tripropylene glycol dimethacrylate, 1,4-butanediol dimethacrylate, 1,6-hexanediol dimethacrylatem, allylated cyclohexyl dimethacrylate, isocyanurate dimethacrylate, ethoxylated trimethylol propane tri-methacrylate, propoxylated glycerol tri-methacrylate, trimethylol propane tri-methacrylate, tris(acryloxyethyl) isocyanurate, and a mixture thereof. Preferably, the acrylate monomers include dipentaerythritol hexaacrylate, trimethylolpropane triacrylate and pentaerythritol triacrylate.

To increase the film-forming properties of the resin coating, the UV curable resins can optionally comprise an oligomer having a molecular weight in the range of 10³ to 10⁴. The oligomers such as acrylate oligomers are well known to a person of ordinary skill in the art. Acrylate oligomers which can be used in the present invention includes, for example but are not limited to, urethane acrylates such as aliphatic urethane acrylates, aliphatic urethane hexaacrylates and aromatic urethane hexaacrylate; epoxy acrylates such as bisphenol-A epoxy diacrylates and novolac epoxy acrylates; polyester acrylates such as polyester diacrylate; or homoacrylates.

Suitable thermosetting resins according to the present invention are those having an average molecular weight in the range of about 10⁴ to about 2×10⁶, preferably in the range of about 2×10⁴ to 3×10⁵, more preferably about 4×10⁴ to about 10⁵. The thermosetting resins according to the present invention can be selected from the group consisting of polyester resins, epoxy resins, polymethacrylate resins, polyamide resins, flouro resins, polyimide resins, polyurethane resins and alkyd resins having a carboxy (—COOH) and/or hydroxy (—OH) group, or a mixture thereof. Among the above, polymethacrylate or polyacrylate resins having a carboxy (—COOH) and/or hydroxy (—OH) group such as polymethacrylate polyol resins are preferred.

Suitable thermoplastic resins according to the present invention are those selected from the group consisting of polyester resins, polymethacrylate resins such as PMMA and a mixture thereof.

The thickness of the resin coating of the optical film according to the present invention usually depends on the requirements of the optical product, and is normally in the range of about 5 μm to 30 μm, preferably in the range of about 10 μm to about 25 μm.

In addition to the organic particles and the binder, the resin coating of the present invention optionally comprises any conventional additives known to a person of ordinary skill in the art such as (but not limited to) leveling agents, stabilizing agents, antistatic agents, hardening agents, fluorescent whitening agents, photo initiators or UV absorbers.

In addition, when the substrate is plastic, inorganic particles which are capable of absorbing UV light can be optionally added to the resin coating to prevent the plastic substrate from yellowing. The inorganic particles include, but are not limited to, zinc oxide, strontium titanate, zirconia, alumina, titanium dioxide, calcium sulfate, barium sulfate, calcium carbonate or a mixture thereof. Among the above, titanium dioxide, zirconia, alumina, zinc oxide or a mixture thereof is preferred. The particle size of the abovementioned inorganic particles is generally in the range of about 1 nm to about 100 nm, preferably about 20 nm to about 50 nm.

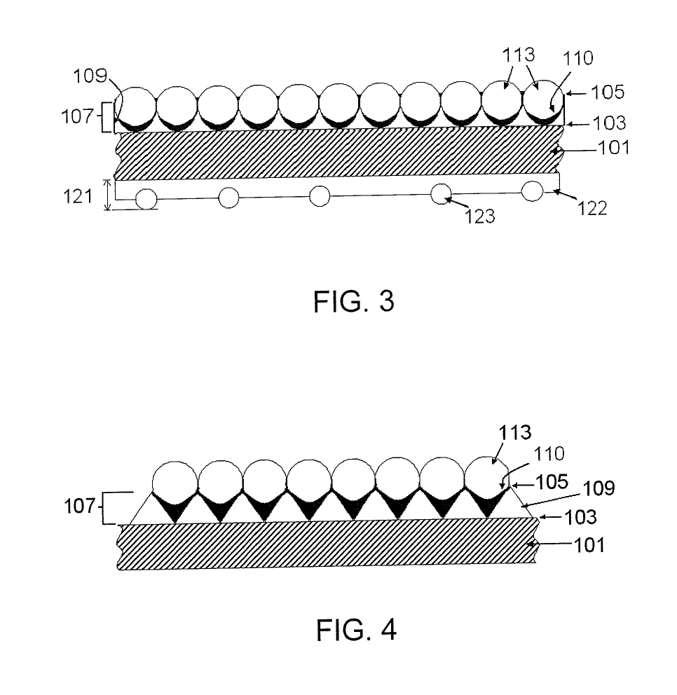

To avoid adhesion between the optical film of the present invention and other components in a backlight module and to enhance diffusion, as shown in FIG. 3, the optical film of the present invention optionally comprises an anti-adhesion layer (121) coated on a surface of the substrate (101) which is opposing to the microstructured layer (107). The thickness of the anti-adhesion layer is about 5 μm to 10 μm. Suitable materials for the binder (122) and the organic particles (123) are as described hereinbefore.

The organic particles in the anti-adhesion layer are in an amount of about 0.1 to about 5 parts by weight per 100 parts by weight of the solids content of the binder. The average particle size of the organic particles is from about 5 μm to 10 μm, preferably about 5, 8 or 10 μm and most preferably about 8 μm.

The anti-adhesion layer and the resin coating of the optical film according to the present invention can be composed of the same or different components.

The optical film according to the present invention has a haze in the range from about 80% to about 98% as measured according to JIS K7136 standard. Preferably, the optical film has a total transmittance of no less than about 60% according to the JIS K7136 standard. Therefore, the optical film of the present invention can be used in light source devices, for example, advertising light boxes and flat panel displays, particularly in liquid crystal displays. The inventive optical film is disposed above the light-emitting surface of an area light source device as a light-converging element. In addition, since the optical film of the present invention is capable of homogenizing light rays as well as enhancing luminance, two or three optical films of the present invention can be used as a substitute for the conventional design having a prism film in combination with other diffusion films.

In addition, since the optical film according to the present invention is capable of homogenizing and converging light rays and the organic particles in the optical film are confined in the grooves between two adjacent columnar structures, problems of aggregation or adhesion of organic particles, such as non-uniform distribution of organic particles or dark spots on a display, associated with conventional diffusion films can be avoided.

The optical film according to the present invention will be further illustrated below in detail by the embodiments with reference to the drawings, which are not intended to limit the scope of the present invention. It will be apparent that any modifications or alterations that can be easily accomplished by a person having ordinary skill in the art fall within the scope of the disclosure of the specification.

FIG. 4 shows a preferred embodiment of the optical film according to the present invention. The optical film comprises a substrate (101) having a microstructured layer (107) on the surface of the substrate, wherein the microstructured layer comprises a plurality of parallel columnar structures (109) and a resin coating comprising a plurality of organic particles (113) and a binder (110). Grooves are formed by two adjacent columnar structures and the binder (110) and organic particles (113) are in the grooves. The distance between the top of at least a part of the organic particles and the bottom of the columnar structures (103) is greater than the distance between the apex (105) and the bottom (103) of the columnar structures.

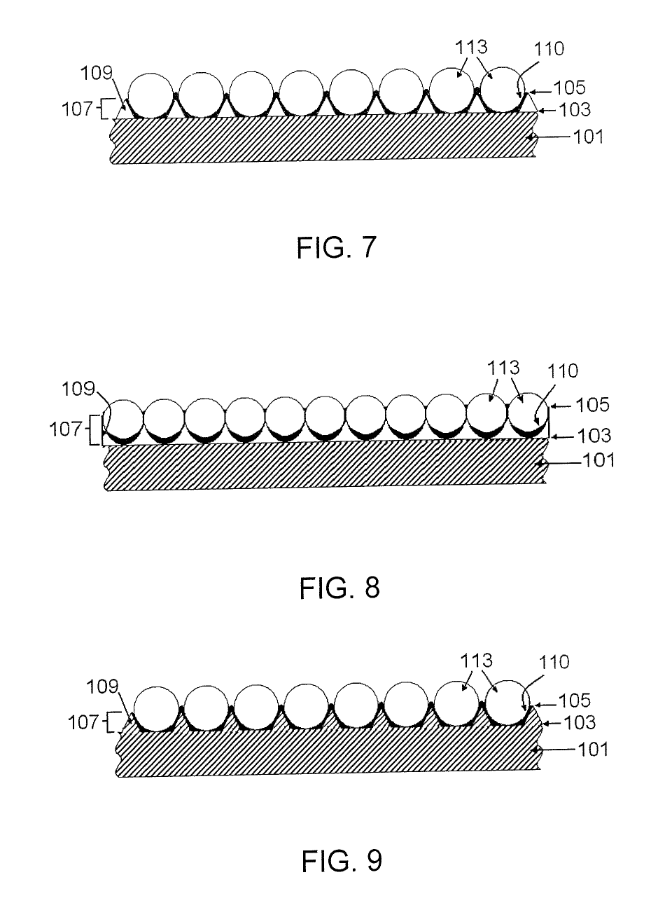

FIGS. 7, 8 and 9 are other embodiments of the optical film according to the present invention. They show that adjacent columnar structures can connect to each other or not.

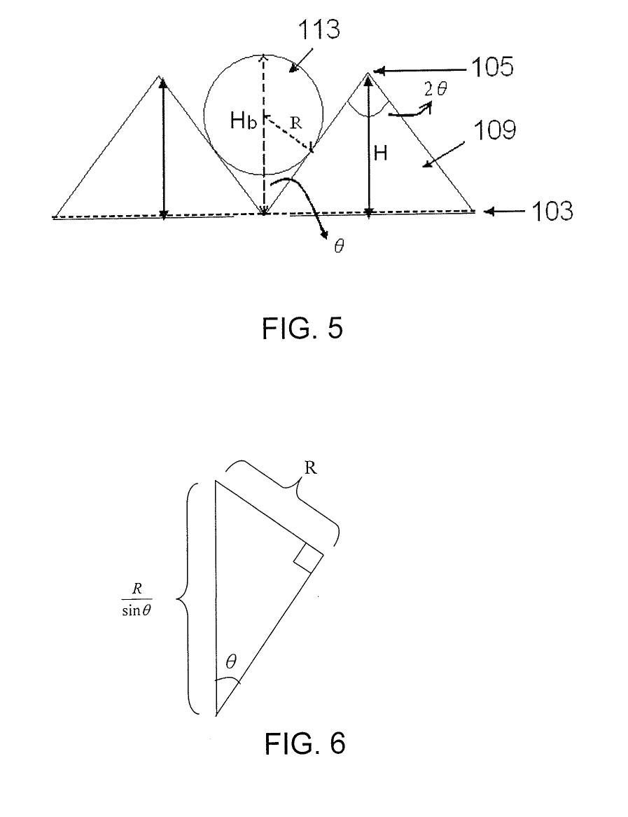

An example in which the adjacent columnar structures connect to each other, i.e., the bottom of a columnar structure (109) is connected to the bottom of an adjacent columnar structure, is shown in FIG. 4. In this case, at least some of the organic particles satisfy the following equation: (1+1/sin θ)R−H≧0 in which H is the vertical distance between the apex (105) and the bottom (103) of the columnar structures, 2θ is the apex angle of columnar structures, R is the radius of organic particles (113) tangent to a columnar structure. FIGS. 5 and 6 are schematic diagrams illustrating the geographical relationship between an organic particle and a columnar structure.

Examples in which the columnar structures are not connected, i.e., there is a certain spacing between adjacent columnar structures (109) and the valley in between is a groove with a flat bottom, are shown in FIGS. 7 and 9. The microstructures shown in FIGS. 7 and 9 are formed by different methods. The microstructures shown in FIG. 7 are formed by applying parallel columnar structures onto a surface of a substrate and the microstructures in FIG. 9 are formed together with the substrate as a unibody.

The columnar structures can be prismatic (109 in FIGS. 4, 7 and 9) or arc-shaped (109 in FIG. 8). When the columnar structures are prismatic columnar structures and two adjacent structures are connected, V-shaped grooves are formed and the organic particles (113) are positioned in the V-shaped grooves (as shown in FIG. 4). When the columnar structures are arc-shaped and two adjacent structures are connected, arc-shaped grooves, which are preferred in the present invention, are formed (as shown in FIG. 8).

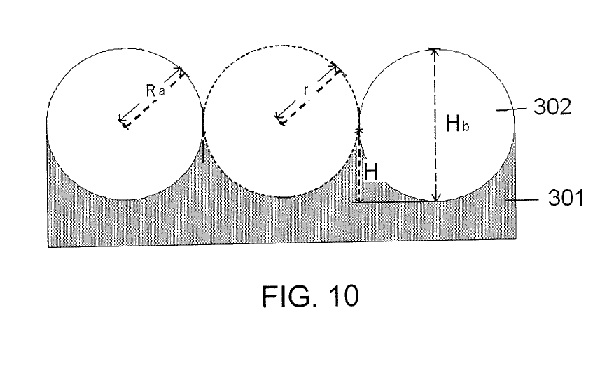

In the optical film according to the present invention, the curve of the arc-shaped groove formed in the microstructured layer (301) is not particularly limited and can be, for example, circular-arc, elliptic or parabolic, and circular-arc is preferred. The radius of curvature (r) of the arc-shaped groove is proportional to the average radius (Rₐ) of the organic particles (302), as shown in FIG. 10. The ratio of r to Rₐ can be from 1:100 to 100:1, preferably from 1:5 to 5:1, and more preferably from 1:2 to 2:1.

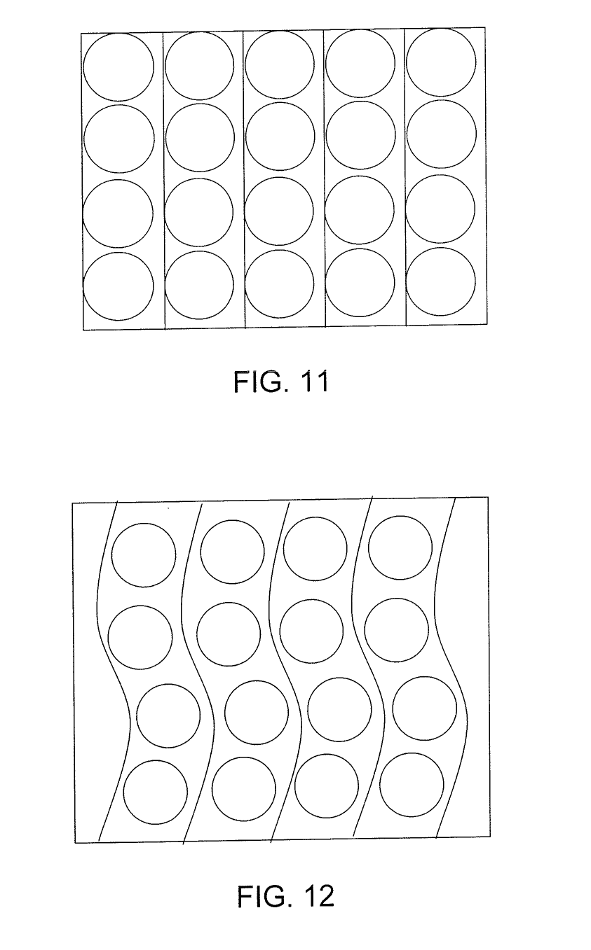

The columnar structures on the optical film according to the present invention can be linear columnar structures with their ridges linearly extending along the length direction, as shown in FIG. 11, or serpentine columnar structures with their ridges windingly extending along the length direction, as shown in FIG. 12.

What is claimed is:

1. An optical film comprising:
a substrate having microstructures; and
a resin coating disposed on the microstructures of the substrate comprising a plurality of organic particles and a binder, wherein said microstructures comprise a plurality of columnar structures that are equilateral and said organic particles are tangent to said columnar structures, and at least part of the organic particles satisfy the equation H_{b}≧H, wherein H_{b} represents the vertical distance between the top of an organic particle to the bottom of a columnar structure and H represents the vertical distance between the apex and bottom of the columnar structure.

2. The optical film of claim 1, wherein the microstructures comprise a plurality of parallel columnar structures.

3. The optical film of claim 2, wherein the parallel columnar structures are of the same height, width and apex angle.

4. The optical film of claim 1, wherein the columnar structures are prismatic columnar structures, arc-shaped columnar structures or a mixture thereof.

5. The optical film of claim 4, wherein the columnar structures are prismatic columnar structures.

6. The optical film of claim 5, wherein the prismatic columnar structures are connected and at least part of the particles satisfy the following equation: (1+1/sin θ)R−H≧0 wherein H represents the vertical distance between the apex and the bottom of the columnar structures, 2θ represents the apex angle of the columnar structures and R represents the radius of the organic particles.

7. The optical film of claim 1, wherein the columnar structures are linear columnar structures, serpentine columnar structures, zigzag columnar structures or a combination thereof.

8. The optical film of claim 1, wherein the columnar structures are linear columnar structures.

9. The optical film of claim 1, wherein the organic particles have an average particle size and the particle sizes of the organic particles fall within about ±30% of the average particle size; and the organic particles are in an amount of about 100 to about 300 parts by weight per 100 parts by weight of the solids content of the binder.

10. The optical film of claim 1, wherein the average particle size of the organic particles is from about 1 μm to about 100 μm.

11. The optical film of claim 9, wherein the particle sizes of the organic particles fall within ±15% of the average particle size.

12. The optical film of claim 1, wherein the substrate and the microstructures thereon are formed together as a unibody.

13. The optical film of claim 1, wherein the substrate having microstructures is formed by applying a plurality of columnar structures on a surface of said substrate.

14. The optical film of claim 1, wherein the organic particles are selected from the group consisting of polyacrylate resins, polymethacrylate resins, polystyrene resins, urethane resins, silicone resins and a mixture thereof.

15. The optical film of claim 1, wherein the surface of the substrate opposing to the surface with the resin coating comprises an anti-adhesion layer.

16. An optical film comprising:
A substrate having microstructures; and
a resin coating disposed on the microstructures of the substrate comprising a plurality of organic particles and a binder, wherein the organic particles are polymethacrylate resins comprising at least one acrylate monomer with a mono-functional group and at least one acrylate monomer with a multi-functional group as polymeric units, wherein the amount of the acrylate monomer(s) having a multi-functional group is about 30 to 70 wt % based on the total weight of the monomers, and the organic particles have an average particle size and the particle sizes of the organic particles fall within about ±30% of the average particle size, and the organic particles are in an amount of about 100 to about 300 parts by weight per 100 parts by weight of the solids content of the binder.

17. The optical film of claim 16, wherein the microstructures comprise a plurality of parallel prismatic columnar structures which are continuously connected and equilateral, the organic particles are tangent to the columnar structures, and at least part of the organic particles satisfy the equation H_{b}≧H, wherein H_{b} represents the vertical distance between the apex of the organic particles to the bottom of the columnar structures and H represents the vertical distance between the apex and bottom of the columnar structures.

18. The optical film of claim 16, wherein the polyacrylate resins are formed from monomers comprising methyl methacrylate and ethylene glycol dimethacrylate.

19. The optical film of claim 18, wherein the amount of the ethylene glycol dimethacrylate monomers is about 30 to about 70 wt % based on the total amount of the monomers.

20. The optical film of claim 16, wherein the thickness of the resin coating is about 5 μm to about 30 μm.

21. The optical film of claim 16, wherein the average particle size of the organic particles is in the range of about 2 μm to about 50 μm.

22. The optical film of claim 16, wherein the organic particles in the resin coating are in an amount of about 100 to about 300 parts by weight per 100 parts by weight of the solids content of the binder.

23. The optical film of claim 16, wherein the substrate is selected from the group consisting of polyethylene terephthalate, polymethyl methacrylate, polycycloolefin resins, triacetate cellulose, polylactic acid and a mixture thereof

24. The optical film of claim 16, wherein the binder is selected from the group consisting of UV-cured resins, thermosetting resins, thermoplastic resins and a mixture thereof.
